(19) United States
(12) Patent Application Publication
(10) Pub. No.: US 2020/0324569 A1
(43) Pub. Date: Oct. 15, 2020

(54) STENCILS AND METHODS FOR BURNING ARTWORK ON SUBSTRATES

(71) Applicant: Lumberjack Tools, Inc., Chippewa Falls, WI (US)

(72) Inventors: Scott Joseph Sullivan, Chippewa Falls, WI (US); Logan Joseph Sullivan, Chippewa Falls, WI (US); Jerry Takeo Judkins, Colorado Springs, CO (US)

(21) Appl. No.: 16/577,682

(22) Filed: Sep. 20, 2019

Related U.S. Application Data
(60) Provisional application No. 62/833,049, filed on Apr. 12, 2019.

(51) Int. Cl. B44B 7/00; B44C 1/24

(52) U.S. Cl. CPC B44B 7/00; B44C 1/24

(57) ABSTRACT

A stencil and method of using the stencil made of a heat and flame resistant material and which includes an opening or openings defining an artwork image. The stencil is used in conjunction with a heat source such as from a flame of a torch to burn or char the artwork image defined by the stencil onto a substrate, and without degradation of the stencil.

### CROSS-REFERENCE TO RELATED APPLICATIONS

This application claims the benefit and priority of Provisional Patent Application Ser. No. 62/833,049, filed Apr. 12, 2019 for Stencils and Methods for Burning Artwork on Substrates, incorporated herein by reference in its entirety for continuity of disclosure.

### BACKGROUND OF THE INVENTION

### 1. Field of the Invention

The present invention relates to methods and devices for applying markings or artwork to materials, and more particularly to stencils and methods for burning or embossing or painting designs or artwork onto substrates.

### 2. Background Information.

Consumers and businesses have often used stencils for marking and decorating objects. At the same time, branding irons have been used for a similar purpose: using heat to burn artwork onto various materials. In the current culture of do-it-yourself projects, consumers desire a better way to achieve a burned, “branded” look on their projects.

Currently there are many companies that produce stencil patterns for various cold-finishing applications such as painting. These stencils are made specifically for low-temperature applications, and limit the user to: paint, marker, pencil, or other similar processes to transfer the stencil artwork to the substrate.

Another available technology to achieve pre-defined artwork in a material surface is the use of branding irons, one example of which is shown in U.S. Pat. No. 1,101,616, granted Jun. 30, 1914. Like with other branding irons, this process first uses a flame or other heating means to heat metal to a highly elevated temperature, then uses this extremely hot metal to burn artwork onto the surface; usually wood or leather.

While the foregoing implements and techniques have useful purposes, there is room for improvement.

### SUMMARY OF THE INVENTION

Applicants have recognized that stencils heretofore manufactured from plastic or paper products do not hold up to a flame or high-temperature exposure for extended periods. Furthermore, Applicants recognize plastic or paper stencils can produce toxic fumes when melted or burned, causing health concerns for the user. Still further, the extreme temperature fluctuation that a branding iron must endure induces warping of the branding iron artwork, requiring either a complex, cost-prohibitive design to minimize the warping, or the user having to limit the design to a simpler iteration of the original artwork. Additionally, the high temperature of the branding iron itself presents a dangerous burn hazard and fire hazard to the user.

Heretofore unrecognized is the opportunity to use a flame in combination with a fireproof stencil to apply markings and artistic images to objects such as wood and leather. Applicants have solved a long-felt problem and need in the marketplace for efficiently and safely applying markings or artwork to objects by providing a method of burning an image onto a wood object by applying a flame to an exposed portion of the wood object to burn the image onto the exposed portion where the exposed portion is defined by an opening in a stencil applied to the wood object, the stencil configured for re-use without degradation when the flame is applied to the stencil. The stencil is fire-proof and is not consumed, nor is the artistic image which is formed by the opening degraded upon application of the flame.

Applicants have also satisfied a long-felt need by presenting a stencil having a relatively thin and inexpensive burn-proof base defining an artwork opening where the artwork opening comprises an internal border of the stencil and configured in the shape of an artistic image and where the stencil retains its shape for reuse even after being burned by a flame from a torch such as a propane or butane torch or infrared heat source or other flame or heat source. The internal border is configured so that an accurate artistic image may be created without fading or blurring or overheating of portions of the image.

While there have been metal stencils in the past, such stencils do not present a single artistic image or single composite image defined by the stencil and/or have not been used in conjunction with a torch flame technique as described herein, or include the particular structural features and advantages of a flat rigid handheld-size sheet of metal as provided herein.

A further aspect of the invention includes a method of burning an image onto an object including applying a flame to an exposed portion of the object to burn the image onto the exposed portion, the exposed portion defined by an opening in a burn-proof stencil applied to the object.

In a further aspect the invention includes of a single-piece or multi-piece stencil that is used in conjunction with a heat source to burn artwork onto the surface of a substrate. The stencil is flexible, or inflexible in one aspect, and made of heat resistant material, allowing the user to burn artwork onto flat surfaces or curved, irregular surfaces. The short duration of heat application by utilizing a handheld propane or butane or gas torch minimizes heat retention in the stencil, making the process much safer than with branding irons. The heat resistant material holds up to the high temperature required for burning artwork onto a substrate, and does not degrade or create harmful fumes like the currently available stencils and techniques. Compared to branding irons, this present process involves a much smaller temperature range, allowing for more complex artwork with a more cost-effective design.

In further aspects the invention includes a metal stencil which withstands application of flame/heat from a torch in order to burn or char an artistic design on a substrate, and also configured for embossing and painting, particularly for receiving a film or leaf of foil or other material thereon which is pressed into the artistic opening to thereby form a resulting artistic image onto or into the film. The same stencil is used to burn, emboss and paint images onto substrates which match the artwork image of the opening defined by the metal base of the stencil.

The above partial summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

Some features of the invention are represented by the accompanied drawings. These drawings capture the major defining features of the invention, but are not intended to encompass every variation of the design.

FIG. 1 is a perspective view of a stencil in accordance with one aspect of the invention.

FIG. 2 is a perspective view of a stencil in a further aspect of the invention and having a different body shape.

FIG. 3 is a perspective view of stencil in a further aspect of the invention.

FIG. 4 is a perspective view of a generic torch heat source for use in conjunction with the invention.

FIG. 5 is a perspective view of a generic wood substrate.

FIG. 6 is a perspective view of a stencil laid out on the surface of a wood substrate of FIG. 5 and in accordance with a method aspect of the invention.

FIG. 7 is a perspective view in accordance with a method aspect of the invention.

FIG. 8 is a perspective view of example artwork burned onto the wood substrate in accordance with a method aspect of the invention.

FIGS. 9-13 depict further stencil aspects of the present invention.

FIG. 14 is a partial front view of an example artwork burned onto the substrate in accordance with a method aspect of the invention.

FIG. 15 depicts a further stencil aspect of the present invention.

FIG. 16 depicts a further stencil aspect of the present invention.

FIG. 17 depicts a further stencil aspect of the present invention and in an embossing technique in conjunction with a representative foil medium.

FIG. 18 depicts a stencil in an embossing aspect of the invention.

FIG. 19 is a perspective view of example artwork embossed onto a substrate in accordance with a method aspect of the invention.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

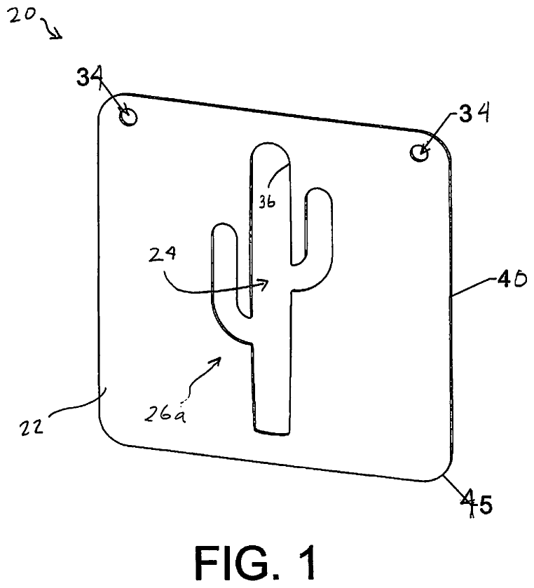

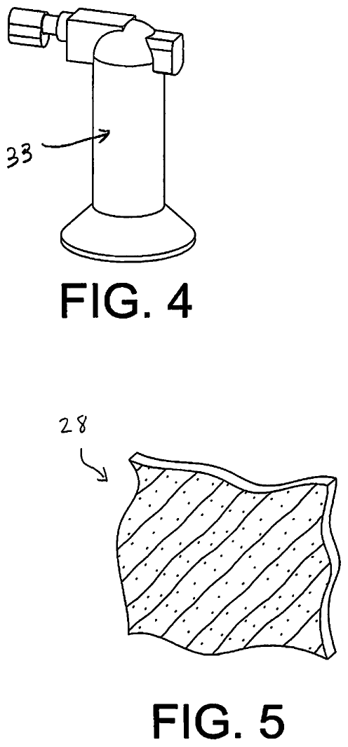

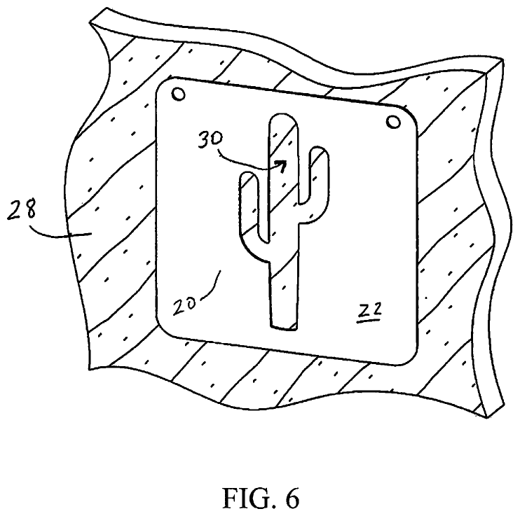

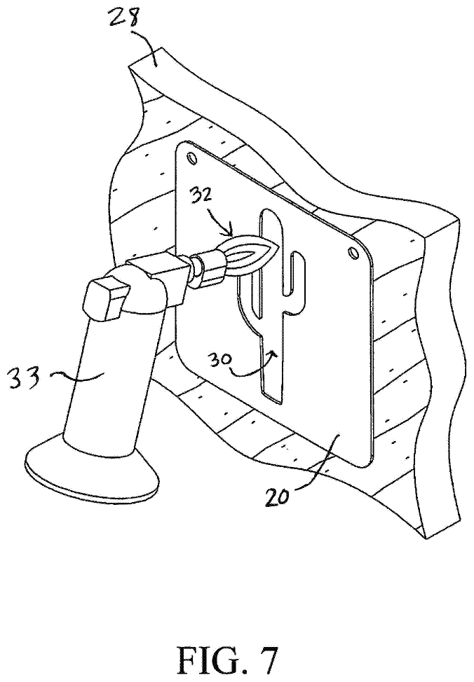

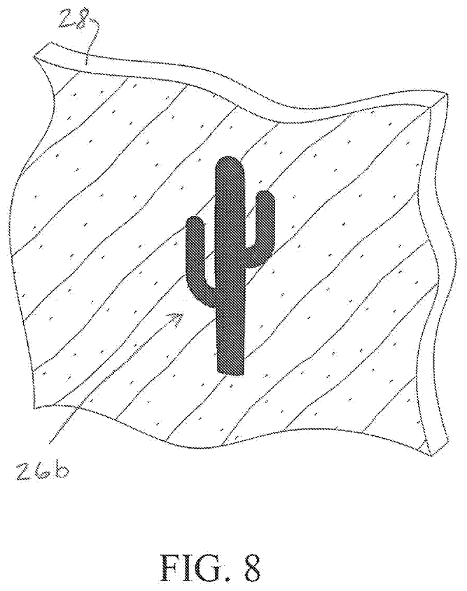

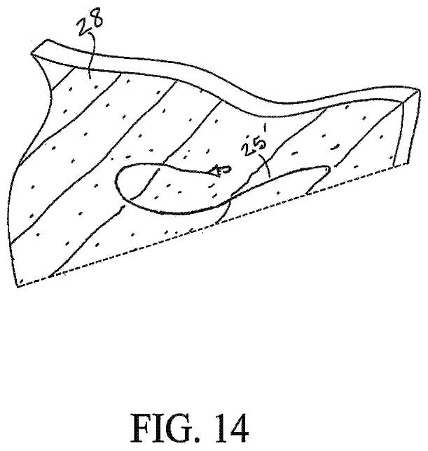

Referring to FIGS. 1-19, aspects of the stencil and methods for burning or embossing or painting designs or artwork on objects are shown. FIG. 1 is a perspective view showing stencil 20 including a base 22 having an opening 24. The opening 24 is in the shape of a design or artwork image 26a to be burned on an object 28. For instance, stencil 20 is applied to an object 28 as in FIG. 6. Thereafter a flame 32 is applied to the object 28 and the stencil 20. The flame 32 burns or chars an exposed portion 30 of the object 28, as in FIG. 7. When the stencil 20 is removed, an image 26b remains on the object 28 as in FIG. 8. The shaded/burned section or artwork image 26b represents the artwork design 26a of the stencil 20 which now exists as a burned section, artwork 26b, on the substrate.

In one aspect the stencil 20 shown in FIG. 1 includes a single opening 24 for the artwork image 26a. The opening 24 may be a single cutout design. In one aspect the stencil base 22 is manufactured from metal, but the material selection includes, and is not limited to, polymers, composites, or any other material suitable to withstand flames and/or high temperatures. In one aspect base 22 is made of silicone or includes silicone as a base material. In a further aspect stencil 20 is made of a base 22 which is a metal plate, such as stainless steel. The base is configured such that even after a flame from a gas torch is applied to the base 22, for instance, the stencil 20 and base 22 retain shape. Stencil 20 and base 22 are not consumed in the heat or flame, do not warp or bend, and produce repeatable artwork images 26b. The stencil 20 is configured for re-use without degradation when the flame is applied thereto. The stencil is burn-proof in that the opening 24 or openings 24 defined by the base 22 are not altered when a flame or heat from a typical hand-held gas-fed torch is applied to the stencil 20. As described further below, stencil 20 may include one or more openings 24 which create artwork 26a of the stencil. The artwork 26a of the stencil 20, upon application of a flame, results in creations of the burned artwork 26b on the object 28.

In one preferred example, stencil 20 is a reusable handheld-size metal stencil, such that the stencil 20 may be handled by a single person and placed onto an object to be treated with artwork. The handheld-size in one example includes a 5 inch by 5 inch plate of steel. In other examples stencil 20 may be larger and still of handheld-size, such as 20 to 25 inches in length or even longer.

In one preferred aspect base 22 is made of a 16-gauge metal sheet or plate material. In a further preferred aspect the base is made of a 16-gauge sheet or plate of stainless steel. The use of 16-gauge metal is important in the present applications because a base 22 having such thickness is relatively thin while achieving desired burn results without warping or overheating. As the thickness of the base increases, such as using 14-gauge or 12-gauge metal, there is an increase in the tendency for the flame to deflect from the edges of the stencil 20, producing a less desirable result. A relatively thick base tends to result in more of a distortion of the image to be burned onto the substrate. While use of stencil 20 having a base 22 of greater thickness (i.e., thickness greater than 16-gauge, such as 14-gauge or 12-gauge) may still produce desired results depending on the artwork pattern and features of the opening 24 and/or skill of the operator, such relatively thick base tends to deflect the flame/heat from the edges of the stencil. Particularly, with 14-gauge thickness, the extra thickness of the base 22 compared to 16-gauge sheet or plate causes the heat/flame from the torch to deflect from or to avoid contact with or along the internal border of the stencil. Applicants have discovered that the greater thickness makes it more difficult to apply a flame to the object along the internal border of the opening 24. A careful or skilled user may still be able to achieve a desired result by angling the torch so that the tip or cone of the flame is directed to where the internal border meets with the object 28, or applying the flame/heat for various durations to assure a desired burn. Using a body 22 with an even greater thickness, such as 12-gauge metal sheet or plate, is even more difficult for the flame/heat to contact the portion of the object 28 along the lower edge of the internal border of the opening 24. While such relatively thick 12-gauge sheets or plates may still be workable, there is an increased opportunity to use a greater variety of artwork images 26 (or more intricate or elaborate images) when using thinner gauge such as 14-gauge or 16-gauge (and even 18-gauge and 20-gauge) metal sheet or plate for the body 22. Ideally the stencil 20 will be as thin as possible to achieve the desired results without warping or overheating. In aspects the body 22 is a rigid sheet of metal or a rigid plate of metal. In various aspects, body 22 may have a thickness from 0.0359 (20-gauge) to ½ inch.

In one aspect, 16-gauge stainless steel presents a sufficiently thick material to avoid warping for these applications, while at the same time being sufficiently thin to allow for details of the artwork image to appear on the substrate. Particularly, use of stainless steel provides a corrosion resistant body which also resists warping due to application of flame/heat from the torch. Use of aluminum by comparison is not as viable an alternative, because, while cost effective, aluminum, for instance conducts and transfers heat too efficiently that improper burning occurs. For instance, the aluminum material tends to heat too quickly and results in the heating of the object 28 beneath the stencil 26. Stainless steel which has a higher insulating property as compared with aluminum has proven to be a better material for producing results with clean defined border lines and is still cost-effective. Moreover, the thickness of the 16-gauge stainless steel resists warping and has been found to retain shape in the present applications. The 16-gauge stainless steel also allows for successive re-use of the stencil 20 because there is little or no warping due to the heating with a torch so that the stencil 20 may be applied to another object 28′ immediately (or nearly immediately) after use with a first object 28. The 16-gauge stainless steel tends to cool swiftly so that it may be re-used immediately or nearly immediately after a first use. The stencil 20 may also be used nearly immediately afterward for embossing and/or painting procedures as noted below. In one preferred aspect, grade 304 stainless steel is used as the base 22. Other varieties or grades of stainless steel may also be used as desired. Different types of metals and alloys may also be used for base 22. In one further aspect base 22 includes 16-gauge grade 304 stainless steel. In most aspects, a plate of 16-gauge stainless steel has a thickness of between 0.0598 inches and 0.0625 inches. The thicknesses may vary depending on manufacturing tolerances. In various aspects, the thickness of the base 22 may vary from 0.032 inches to 0.500 inches.

Applicants have also found that use of 16-gauge stainless provides a sufficiently narrow thickness to provide a sufficiently high-level of detail for the artwork 26. The thicker the base 22, the less detail can be cut into the design because the flame/heat tends not to reach the object 28 with the thicker material as noted above. The level of detail that can be achieved by conventional manufacturing methods decreases as the thickness of the material increases.

Artwork 26a portrayed in stencil 20 may include, and is not limited to, geometric shapes, alphanumeric, scenery, persons, living creatures, cosmic entities, cultural symbols, religious symbols, animals, fish, birds, footprints, trees, cabin images or images of other objects. One or more optional holes 34, round or otherwise, may be integrated into stencil 20 to facilitate storage, alignment, or retail display. Stencil 20 and base 22 may have one or more exterior edges 40. As in FIG. 1, edges 40 of stencil 20 are straight, and external corners 45 curved, or irregularly shaped. External corners 45 may be rounded or contoured to enhance safety by eliminating sharp corners. In one aspect as shown in FIG. 1, stencil 20 has a base 22 defining a single opening 24 comprising a single artwork image 26a. The opening 24 has a continuous internal border (or edge) 36. The single, continuous internal border 36 is shaped to form a desired and single artwork image 26a.

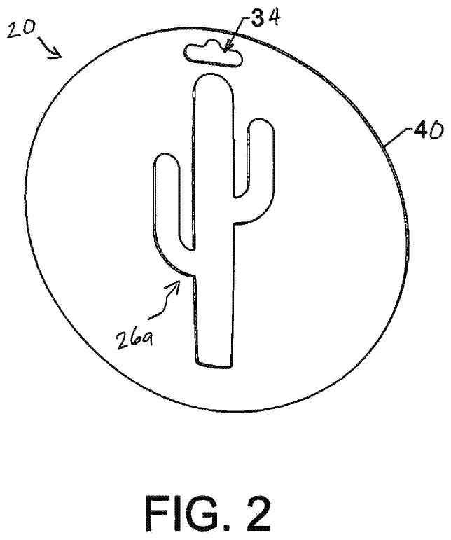

FIG. 2 depicts stencil 20 with the same artwork 26a as with stencil 20 shown in FIG. 1, but has a single exterior edge 40 forming a round perimeter. This stencil 20 of FIG. 2 has the same defining features, including, an artwork 26a formed by opening 24, and an optional hole 34 to facilitate storage, alignment, or retail display. Stencil 20 and base 22 may be made of different shapes and sizes as desired.

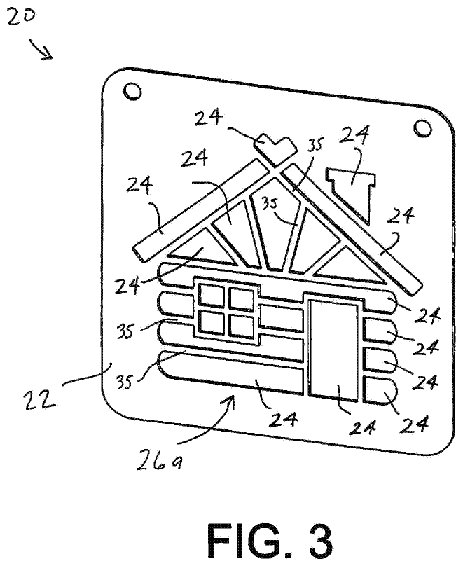

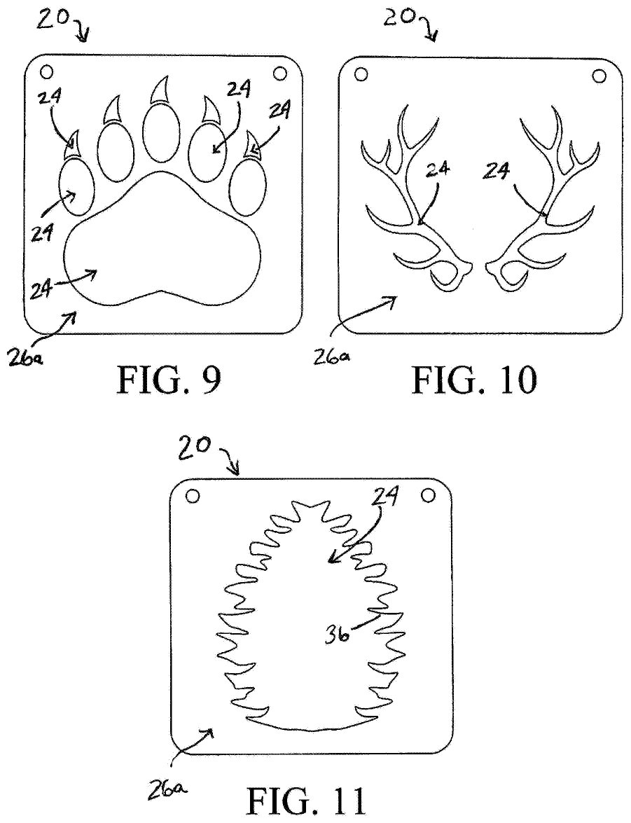

In FIG. 3, a more complex stencil 20 is illustrated with a heat-resistant base 22. This design or artwork 26a includes twenty-two (22) individual openings 24 (or “cutouts”) which collectively create the desired artwork 26a, 26b. The plurality of openings 24 form a composite unitary image. In this instance, the artwork image 26a comprises an image of a cabin. Stencil 20 may be configured with one of many different artwork images 26. In alternative aspects, stencil 20 may be configured with several separate (the same or unique) artwork images 26. For instance, stencil 20 may include multiple images 26a of a cactus or other artwork. In alternatives, artwork image 26a is a unitary image comprising multiple openings 24, as with the stencil of FIG. 3, FIG. 9, FIG. 10 and FIG. 11. The multiple openings 24 work together to create a single artwork image 26a, 26b (or an artwork image that appears to be a single item such as a paw print, antler rack, cabin or other object).

The stencil 20 of FIG. 3 demonstrates use of multiple openings 24 to create complex patterns forming a simple artistic image on a relatively thin base 22 for inexpensive manufacture of the stencil and inexpensive and efficient burning of an artwork image 26b. The stencil 20 avoids the problems associated with a traditional branding iron which must be heated to an extreme temperature, is expensive and difficult to manufacture (especially if it includes several separate elements of a composite image) and difficult and dangerous to apply. Stencil 20 is only lightly heated for masking and applying the burn artwork image 26b, requiring less operation time and less danger in application. The stencil 20 may be easily and quickly moved and reused. Stencil 20 is easily packaged, stored and shipped.

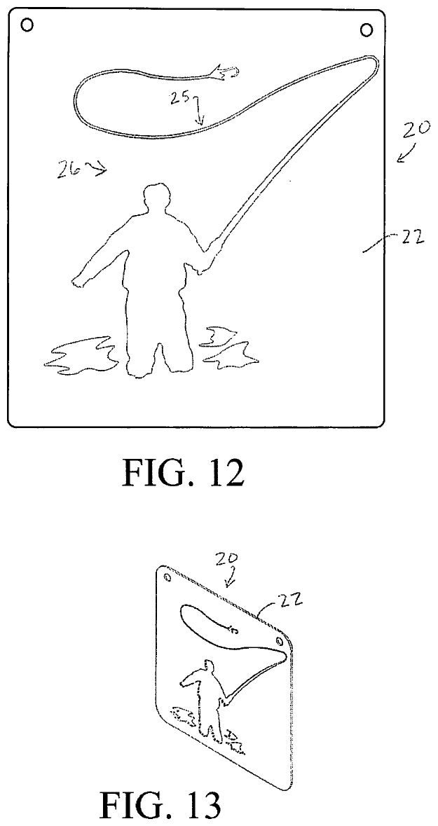

In further aspects, in combination with a base 22 having a 16-gauge thickness (or other thicknesses as noted above), particular features of the opening 24 are limited in one aspect of the invention. Specifically, in order to have small image features burned onto the object 20 (such that the heat/flame passes through an opening 24), the width of the opening for such smaller features has a minimum width of 1/16 inches. For instance, with respect to FIGS. 12-14, to properly burn the smaller features of a fishing line 25, for instance, the width of the opening 24 representing the fishing line 25 must be much larger than the width of the resulting fishing line image 25′ burned on the object 28. For instance, the opening 25 has a width of at least 1/16 inches in order for a resulting narrow “fishing line” 25′ to be burned on the object 28 where the actual width of the burned “fishing line” is much narrower than 1/16 inches. As can be seen in FIG. 12, the fishing line opening 25 is comprised of a double-line feature defining the fishing line gap or opening 25. Whereas the resulting image of the “fishing line” 25′ on the object 28 of FIG. 14, is a single line 25′ which is much narrower and more representative of a realistic looking fishing line. Other small image aspects, such as feathers, stars, string, claws may also be formed on an object 28, yet the width of such features depicted in the opening 24 on the stencil 20 have a minimum width of 1/16 inches when utilizing a 16-gauge sheet or plate material. Different minimum widths are used when dealing with different thicknesses of sheet or plate material.

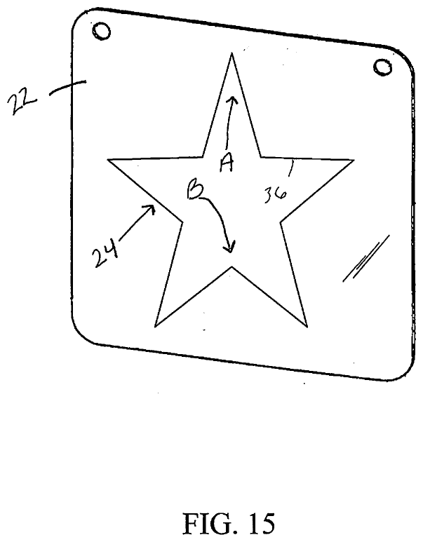

In further aspects, the internal border 36 of opening 24 is configured with advantageous burn and safety characteristics of stencil 20. Particularly, with reference to FIG. 15, in one aspect the internal border 36 defines one or more acute-angled corners “A” or 50 having a concave radius of at least 0.006 inches. The respective sides do not merely come to a point or define a sharp angle in this example. Such minimum radius of 0.006 inches is needed to provide a sufficient opening or space to receive the heat/flame. If the sides of border 36 forming corner 50 come to a point, for instance (or even less than 0.006 inches), the heat/flame applied to the corner 50 will deflect from the stencil 20 or not be able to penetrate the object 28 along the sides, thus resulting in unburned or under-burned areas. The unburned or under-burned areas will appear fuzzy or blotched, and lack the desired crisp lines of the intended artwork design. In other aspects, a user will hold the flame/heat at such corners 50 for a prolonged period of time, thereby overheating the stencil 20 at such corner areas 50 which results in unwanted burning of the object 28 under such corner areas 50. These “overburned” areas will appear cloudy and fuzzy and radiate outward from the otherwise clean border edges of the artwork. The result of having corners with a minimum radius of 0.006 inches is that sufficient flame/heat is applied to the corners 50 for a uniform and clean coverage of the flame, resulting in well-defined corners. The use of 16-gauge thickness metal body 22 will also eliminate or reduce warping so that the artwork image can be produced with clean border edges. In further aspects, the acute-angled corners “A” have a concave radius of between at least 0.006 inches and 0.030 inches, and in some instances between 0.006 inches and 0.250 inches. Such radius also provides a safety feature in reducing converging sharp edges which might otherwise cause pinching or cuts to fingers slid along the sides of the border 36 toward corners 50.

Further with respect to FIG. 15, internal border 36 defines one or several obtuse-angled corners “B” or 52, each having a convex radius of at least 0.010 inches. Such rounded corner avoids a sharp point which would otherwise quickly heat and tend to cause burning beneath the stencil 20 at the point 52. Having the rounding or radius of at least 0.010 inches more evenly distributes the flame/heat applied to the corners 52 for a better burn result. If the corner otherwise comes to a clean point, the flame and heat will tend to burn beneath the stencil 20 at the sharp point, resulting in a blurred image. The use of the radius also provides a safety benefit so that fingers inserted into opening 24 are not subjected to sharp edges. In alternative aspects corners A and B may be designed with sharp corners without radii, or some corners may have a radius and others without a radius.

In further aspects, artwork opening 24 includes multiple openings 24 which comprise the desired shape. With reference again to FIG. 3, some openings 24 are separated by webbings 35 defined between at least two of the multiple openings. For instance, webbings 35 may separate adjacent “logs” of the log cabin artwork 26 shown in FIG. 3. Webbings 35 may also separate rafters shown in the same Figure. The webbings 35 serve a number of roles. In one instance, webbings 35 have a width of no less than 1/16 inches so that they sufficiently mask the flame/heat applied to stencil 20 so that there is separation appearing between adjacent openings 24, such as the mortar or separation between adjacent “logs” of the cabin. If the webbings 35 are narrower than 1/16 inches in conjunction with a 16-gauge base 22, the “logs” 24 will tend to blur at the edges and might even appear to blur together in areas. The webbings 35 which form “rafters” in FIG. 3, while also showing separation between adjacent openings 24, serve another purpose of limiting or preventing warping of stencil 20. Otherwise, the larger open areas that would exist if webbings 35 were absent would tend to cause the base 22 to warp at areas of the stencil.

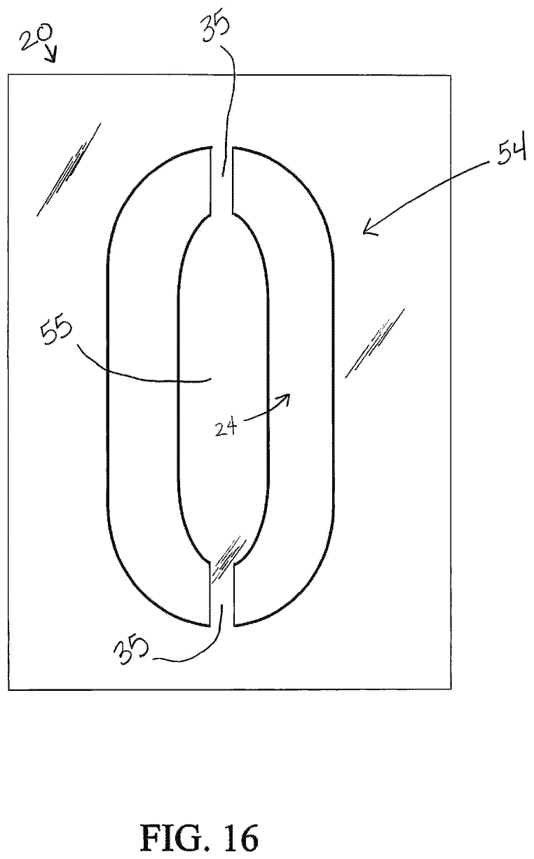

In further aspects with respect to FIG. 16, the webbing 35 is used to form artwork images 26 having suspended center features (“Suspended Center Features”), such as with certain letters or number. For example, with the letter “O”, the center portion 55 of the letter “O” 54 is preferably presented as “suspended” inside the outer border of the “O” as generally shown in FIG. 16. Webbings 35 are used to suspend such center feature 55. There are other artwork images 26, such as letters and number or other objects which have Suspended Center Features where webbings 35 or tabs are used to create the suspension. In some aspects, the webbings 35 for such Suspended Center Features have a width of less than 1/16 inches so that such webbings 35 become less pronounced (or block less flame/heat) such that the webbings 35 “disappear” in the final burn image or appear less pronounced (or the material beneath the webbings 35 will nonetheless burn or char). In manufacture and design of stencils 20, webbings 35 may be used with different widths depending on whether the end features of the artwork are to have the webbing areas masked or somewhat revealed. Adjusting the width of the webbings 35 allows the designer of the stencil 20 to create a variety of desired artwork images 26.

Methods for manufacture of stencil 20 vary based on the material of base 22 selected. Some non-limiting and non-exclusive methods of manufacture of stencil 20 include (whether ferrous or non-ferrous): blanking, laser-blanking, waterjet, plasma cutter, photo etching, casting, or machining. One or more finishing operations may be included after manufacturing to clean or apply finish to the surface of stencil 20. A finishing operation may include, but is not limited to, acid bath, anodizing, electro-plating, chemical plating, paint, powder coat, or conversion coating. Manufacturing of polymer or composite stencils 20 include, for instance: injection molding, 3D printing, machining, laser-blanking, waterjet, casting, or thermoforming. Similarly, one or more finishing operations may be applied to the polymer or composite to clean, smooth, or add a finish to the surface of stencil 20. This finish may include, but is not limited to, abrasive media, solvent, paint, or an additional polymer coating. In a further aspect stencil 20 may be made of a base 22 comprising a silicone material. The silicone material is flame proof or flame-resistant and allows the base 22 to be somewhat flexible. The flexible base 22 in some applications is wrapped about an object 28 to be marked with the burned artwork 26b, such as a curved post or other non-flat object or object having a non-flat surface.

Further use or method aspects of the invention are described below. These examples shall not be considered limiting the function of the invention, as there are many variations of use that shall be considered normal operation of the invention.

In one method aspect, an image is burned onto an object such as a wood substrate or leather piece by applying a flame 32 as noted herein. In one aspect stencil 20 is utilized by applying a heat source, typically a flame from a gas-fueled torch 33, to burn artwork 26b onto the chosen substrate or object 28, such as a substrate or layer of wood or leather. The torch 33 in some aspects include a butane or propane torch, and in further aspects the flame or heat source includes an infrared heat source. The object 28 or substrate is chosen, which in one aspect is ideally flat, but may be curved or irregular. The stencil 20 is placed on the substrate 28 and positioned in a location where the user requires the burned artwork 26b to be positioned, as in FIG. 6. The user applies a flame 32 from torch 33, or other flame or heat source, to the substrate surface. Particularly, the flame 32 or heat is applied directly to an exposed portion 30 of the substrate or object 28 as in FIG. 7. The flame is directed inside the opening 24 (or openings 24) of stencil 20 as much as possible. The stencil 20 protects the non-exposed areas from the flame 32. A user will use their best judgement to determine the intensity and duration of the flame or heat to transfer the artwork 26b desired onto the substrate. After artwork 26b is burned onto the substrate 28, the torch 33 or flame 32, or other heat source, is removed. Stencil 20 is removed from the substrate 28. What remains is the burned artwork 26b of stencil 20 on the surface of the substrate as in FIG. 8. This process may be repeated numerous times to create a coherent image, such as multiple animal tracks or a word or phrase. This process may also be repeated numerous times to create an incoherent group of images, such as, a dog, a sports car, a computer or other image. In one aspect the flame 32 is applied by a user hand-guiding the torch back and forth (or in various spanning motion) about the exposed portion of the object 30. In other aspects, the application of heat or flame 32 may be accomplished motion of a machine or robotic action. The stencil 20 may be applied to the object by simply laying stencil 20 upon the object 28. In other cases, stencil 20 may be connected to the object, via holes 34 or otherwise, so that flame 32 may be applied to the exposed portion 30. The flame or heat is passed about the entirety of the opening 24 or openings 24 of stencil 20 to provide a complete and finished artwork object 26b.

While using stencils as a guide for various artwork is not a new concept in itself, and there are manufacturers that offer stencils with various artwork, one aspect which makes this invention special is the combination of a heat-resistant or flame resistant (of flame proof) base 22 and the process of burning artwork 26a using a flame and stencil combination. The stencil 20 is reusable for additional flame burning applications. Such combination avoids use of a hazardous, red-hot branding iron or wood burner. The present stencils are long-lasting and provide repeatable images without degradation, and the methods of burning an image greatly reduce health and safety concerns that currently plague consumers given the limited options available for branding wood or leather. Use of particular radii for the internal border angles, in conjunction with 16-guague stainless steel provide a desired mix of features which produce repeatable clean artistic images at relatively low cost.

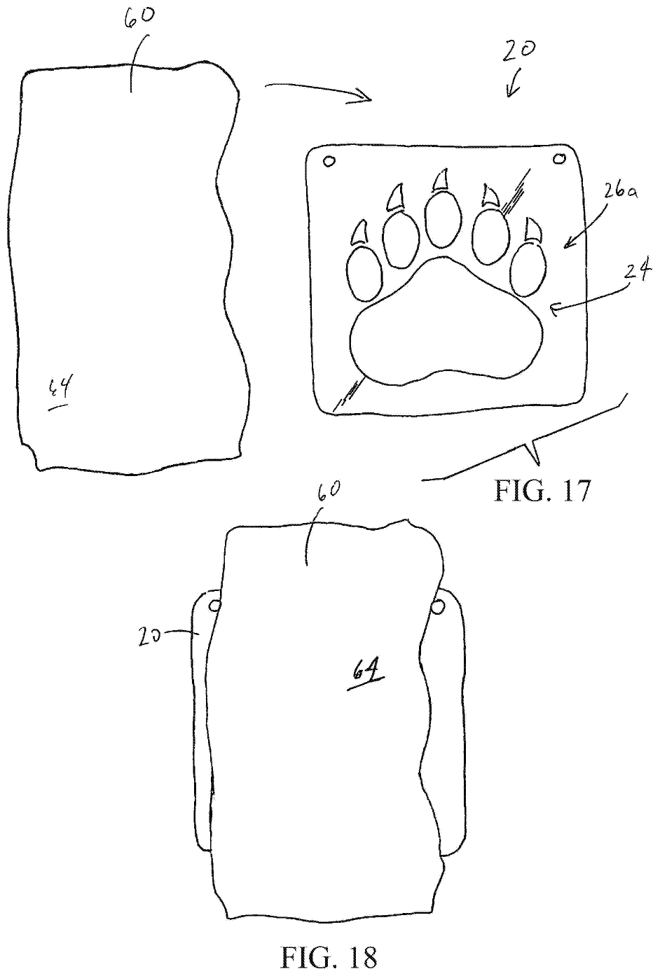

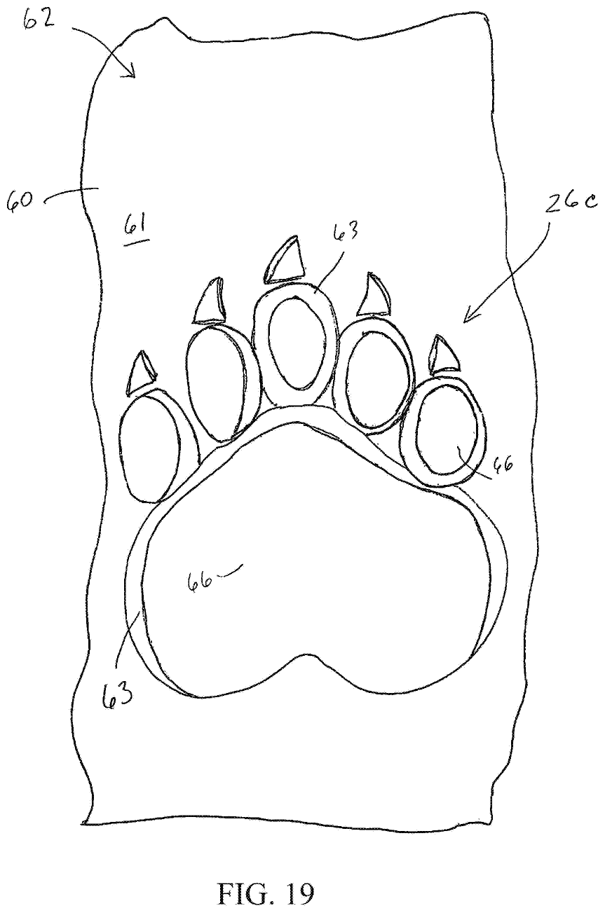

In further aspects, stencil 20 is universal in that it may be used to burn images on substrates, and also used for embossing images onto materials and for painting images onto objects. For instance, stencil 20 having a body 22 made of 16-gauge (or other gauge) metal provides a sufficient thickness of material to allow the stencil 20 to operate in an embossing process. Particularly, with respect to FIGS. 17-19, a foil 60 or other light-weight malleable or slightly flexible material (such as aluminum foil, including crafting foil) is applied to a stencil 20. The stencil 20 is typically placed on a table or other firm object. The foil 60 is placed on top of the stencil 20 (FIG. 18) and is pressed downward into the opening 24 of the stencil to create an embossment or embossed foil 62 having an embossed image 26c (FIG. 19). Portions of the foil 60 are pressed downward into the opening 24 to the table upon which the stencil 20 is placed. The foil 60 is pressed downward into the opening 24 by pressing with fingers or pounding with hammers or pressing with screwdrivers or with other tools to force the foil downward into the openings and to the table. The foil 60 will have several depressions or angled depressions 63 which lead from a top side 64 of the foil to a back side 61 of the foil 60. The depressions 63 actually extend outward from the backside 61 of the foil 20. The portions of the foil that are pressed against the table form outward surfaces 66 of the embossed foil 62. The outward surfaces 66 extend outward from the back side 61 of the foil 60 to produce a three-dimensional image or embossment. A reverse of the same embossment (as a depression) is presented at the top side 64 of the resulting embossed foil 62. The same stencil 20 may be used for the burning operations noted above, whether used before or after the embossing operations stated herein. The thickness of the stencil allows for rapid cooling and swift use after used as a burn stencil, and the thickness also provides a desired embossing stencil to fabricate artwork.

In a further aspect stencil 20 is placed on an object and a paint or paints or other materials are applied to the opening 24 to create an artwork image 26 on the object. In aspects the paint or other material may be applied by brushing or blotting or spraying other methods. In the case of a stainless steel stencil 20, the paints or other materials wipe easily from the surface and edges of the body 22. The universal stencil 20 may thus be used as a burning stencil, a painting stencil and an embossing stencil, and the order of use may be varied as desired. The flatness of the base 22 allows for stencils 20 to be conveniently stacked, stored, packaged and shipped.

The invention described by this document references the ideal or common iterations of the invention, but in no way limits the invention to the described methods, procedures, or design elements. It will be apparent to anyone in the trade to which this invention belongs, that different iterations of the invention may perform the same functions. These iterations are considered within the scope of the current invention, and are meant to be included by the following claims.

What is claimed is:

1. A stencil comprising:
a reusable handheld-size metal sheet defining an opening, the opening comprising an internal border of the stencil and configured in a shape to be burned onto an object when the object is subjected to a flame or heat of a gas-fed torch applied through the opening while the sheet is placed on the object, the sheet being such that the opening retains its shape even after the sheet is subjected to flame or heat from the gas-fed torch.

2. The stencil of claim 1 where the sheet is a flat rigid sheet of 16-gauge stainless steel.

3. The stencil of claim 2 where the opening is configured in a shape from the group of an animal, fish, bird, plant, tree, person, foot print, paw print, hoof print, antler, cabin image, letter, number, geometric shape, scenery, cosmic entity, cultural symbol, holiday symbol, and religious symbol.

4. The stencil of claim 2 where the internal border defines one or more acute-angled corners and one or more obtuse-angled corners, each acute-angled corner having a radius of at least 0.006 inches, and each obtuse-angled corner having a radius of at least 0.010 inches.

5. The stencil of claim 2 comprised of 304 Stainless Steel.

6. The stencil of claim 2 having a sheet thickness of between 0.0598 inches and 0.0625 inches.

7. The stencil of claim 2 where the shape comprises a small image from the group of a feather, star, string, claw and line, the small image formed using an opening having a minimum width of 1/16 inches.

8. The stencil of claim 2 where the opening comprises multiple openings to comprise the shape, a webbing defined between at least two of the multiple openings, the webbing having a width of at least 1/16 inches.

9. The stencil of claim 2 where the opening comprises multiple openings to comprise the shape, a webbing defined between each of the openings where each webbing has a width of no less than 1/16 inches.

10. The stencil of claim 2 where the opening comprises multiple openings to comprise the shape, a webbing defined between at least two of the multiple openings to define a suspended center feature, the webbing having a width of less than 1/16 inches.

11. The stencil of claim 1 where the opening is configured in a shape from the group of an animal, fish, bird, plant, tree, person, foot print, paw print, hoof print, antler, cabin image, letter, number, scenery, cosmic entity, cultural symbol, holiday symbol, and religious symbol.

12. The stencil of claim 11 where the sheet is a flat sheet having a uniform thickness, the thickness ranging between 20-gauge and ½ inch.

13. A method of burning an image onto an object, comprising applying a flame to an exposed portion of the object to burn the image onto the exposed portion, the exposed portion defined by the opening in the stencil of claim 1.

14. A stencil, comprising:
a reusable handheld-size flat metal sheet defining an artwork opening, the artwork opening comprising an internal border of the sheet and configured in an artistic shape to be burned onto an object when subjected to a flame or heat of a gas-fed torch applied to the opening, the internal border defining one or more acute-angled corners and one or more obtuse-angled corners, each acute-angled corner having a radius of at least 0.006 inches, and each obtuse-angled corner having a radius of at least 0.010 inches.

15. The stencil of claim 14 where the artwork opening is configured in a shape of one from the group of an animal, fish, bird, plant, tree, person, foot print, paw print, hoof print, antler, cabin image, letter, number, geometric shape, scenery, cosmic entity, cultural symbol, holiday symbol, and religious symbol.

16. The stencil of claim 15 where the flat metal sheet comprises 16-gauge stainless steel.

17. The stencil of claim 16 where the artwork opening comprises multiple openings to make the shape, a webbing defined between at least two of the multiple openings, the webbing having a width of at least 1/16 inches.

18. A method of burning an image onto an object, comprising applying a flame or heat from a gas-fed handheld torch to an exposed portion of the object to burn the image onto the exposed portion, the exposed portion defined by the opening in the stencil of claim 14 when the stencil is placed on the object.

19. A method of burning an image onto an object, comprising:
applying a flame or heat to an exposed portion of the object from a handheld gas-fed torch to burn the image onto the exposed portion, the exposed portion defined by an opening in a stencil applied to the object, the stencil comprised of a handheld-size flat, substantially rigid sheet of metal.

20. The method of claim 19 where the sheet of metal comprises a rigid stainless steel sheet, the method further comprising the step of placing the stencil on the object prior to the step of applying a flame or heat, the opening comprising an internal border of the steel sheet, the internal border defines one or more acute-angled corners and one or more obtuse-angled corners, each acute-angled corner having a radius of at least 0.006 inches, and each obtuse-angled corner having a radius of at least 0.010 inches.

21. The method of claim 19 further comprising:
removing the stencil from the object;
positioning a metal foil upon the stencil, the stencil comprised of stainless steel having a thickness of at least 16-gauge; and
pressing at least portions of the metal foil into the opening of the stencil to emboss an image into the metal foil corresponding to the opening.

22. The method of claim 19 further comprising:
removing the stencil from the object;
positioning the stencil upon another object; and
applying paint to the another object through the opening.
